(19) United States
(12) Patent Application Publication
(10) Pub. No.: US 2024/0135339 A1
(43) Pub. Date: Apr. 25, 2024

(54) SECURE AND COMPLIANT MULTI-CRYPTOCURRENCY PAYMENT GATEWAY

(71) Applicant: NOVATTI GROUP LIMITED, Melbourne, Victoria (AU)

(72) Inventors: Nalaka GOONERATNE, Melbourne, Victoria (AU); Prasan FERNANDO, Melbourne, Victoria (AU); Kian JACKSON, Melbourne, Victoria (AU)

(73) Assignee: NOVATTI GROUP LIMITED, Melbourne, Victoria (AU)

(21) Appl. No.: 18/546,615

(22) PCT Filed: Feb. 16, 2022
(86) PCT No.: PCT/IB2022/051351

§ 371 Date: Aug. 15, 2023

(30) Foreign Application Priority Data
Feb. 16, 2021 (AU) 2021900385

(51) Int. Cl. G06Q 20/02; G06Q 20/36; G06Q 20/38; G06Q 20/40

(52) U.S. Cl. CPC G06Q 20/027; G06Q 20/3678; G06Q 20/381; G06Q 20/4016; G06Q 2220/00

(57) ABSTRACT

A secure multi-cryptocurrency payment gateway is provided. An interface is provided to a customer to select the cryptocurrency exchange may include a login uniform resource locator (URL) of a cryptocurrency exchange. Alternatively, the interface provided to the customer to select the cryptocurrency exchange may include a quick response (QR) payment code for the cryptocurrency exchange. Alternatively, the interface provided to the customer to select the cryptocurrency exchange can include a first further token that includes the token representing the payment request, the first further token allows the customer to authorize the cryptocurrency exchange to send the payment gateway a second further token including the first further token that allows the payment gateway to retrieve a balance amount and a transaction history of the cryptocurrency wallet of the customer.

### CROSS-REFERENCE TO RELATED APPLICATIONS

This application is a national stage application, filed under 35 U.S.C. § 371, of International Patent Application No. PCT/IB2022/051351, filed on Feb. 16, 2022, which claims priority to Australian Patent Application No. 2021900385, filed on Feb. 16, 2021, the entire contents of each of which is incorporated by reference herein in its entirety.

### BACKGROUND

### 1. Field of the Disclosure

The present invention relates generally to cryptocurrency payment gateways.

### 2. Description of the Related Art

Payment gateways allow merchants to accept payments by connecting payment processors with merchant account providers. In some cases, these payment gateways themselves act as the account provider, either by issuing accounts or providing sub accounts linked to the gateway's own merchant account. In the latter, payment gateways bear liabilities related to anti-fraud and anti-money laundering regulations for the processed transactions. With traditional payment methods such as credit card, debit card, stored value wallets (Alipay, WeChatPay, PayPal), payment gateways protect legitimate consumers by performing anti-fraud assessments, throttling payments, and verifying advisory lists, and as a last resort, triggering chargeback processes. Similarly, to protect merchants, features such as anti-fraud assessments, 3DS verifications, and charge-back guarantees are offered as value added services, when processing payments. However, with current facilities that are available in the market, it is not possible to perform anti-fraud and anti-money laundering assessments when processing cryptocurrency payments due to the anonymous nature of such transactions. Cryptocurrency is on the verge of getting broad acceptance as a form of payment for products and services. However, existing solutions for processing cryptocurrency payments for e-commerce transactions suffer from several drawbacks.

For example, current mechanisms that allow merchants accept cryptocurrency as payment for goods and services rely on merchants directly integrating with cryptocurrency exchanges on a one-to-one relationship basis. Such mechanisms do not offer credit card, debit card or store value wallets as alternative payment options. It is therefore difficult for merchants to offer cryptocurrency as an integrated payment option, alongside other payment methods, to consumers. In such an environment, merchants must develop their own integrated hosted payment page/component, and it may not be possible for all transactions performed on the merchant's e-commerce site to be settled into a single acquiring fiat account.

Another drawback with currently available solutions, is that the way merchants integrate with cryptocurrency exchanges are different from the way they integrate with payment gateways to accept payments with credit card, debit card or store value wallets. Previously proposed solutions relied on a progressive web application being developed by the merchant that requires consumers to have a mobile application which converts cryptocurrency to fiat currency, and then processes the payment through payment card rails.

When performing fraud assessments on payments with cryptocurrencies, current technologies do not consider a risk mitigation approach. They do not consider the source of the fiat funds used to obtain the cryptocurrency or the contents of the relevant shopping basket to determine high risk transactions. One proposed approach attempts to prevent fraudulent transactions from being accepted to a blockchain by inspecting all the transactions of a block to identify those mined by a fraudulent entity. Another proposed solution proposes an approach where cryptocurrency wallets are linked to fiat currency wallets, and aggregate user profiles are held in an exchange by linking the wallets. Then, AML (Anti Money Laundering) and anti-fraud assessments are performed based on the aggregate user profile. However, implementation of such a mechanism is not possible with current mainstream cryptocurrencies such as Bitcoin, Ethereum, Litecoin, XRP, etc.

In view of this background, there is a need for a secure and compliant multi-cryptocurrency payment gateway.

It is a preferred object of embodiments of the present invention to at least partially address or ameliorate one or more of the above disadvantages, or at least provide a useful alternative.

### SUMMARY

According to the present invention, there is provided a system, comprising: a memory; and
a processor configured by instructions stored in the memory to:
   receive, at a payment gateway, a payment request and shopping basket details of a customer from a merchant, wherein the payment request comprises a request for the payment gateway to pay a fiat currency amount to the merchant after an equivalent cryptocurrency amount has been transferred from a cryptocurrency wallet of the customer to a cryptocurrency wallet of the payment gateway;
   generate a token representing the payment request;
   store the token and the shopping basket details for subsequent processing of the payment request by the payment gateway;
   provide an interface to the customer to select a cryptocurrency exchange to transfer the equivalent cryptocurrency amount from the cryptocurrency wallet of the customer to the cryptocurrency wallet of the payment gateway;
   request the cryptocurrency exchange to sell the equivalent cryptocurrency amount in the cryptocurrency wallet of the payment gateway for the fiat currency amount;
   receive a transfer of the fiat currency amount from the cryptocurrency exchange to the payment gateway;
   notify the merchant and the customer that the payment request has been successfully processed by the payment gateway;
   settle the payment request by transferring the fiat currency amount from the payment gateway to the merchant.

The interface provided to the customer to select the cryptocurrency exchange may comprise a login uniform resource locator (URL) of the cryptocurrency exchange.

Alternatively, the interface provided to the customer to select the cryptocurrency exchange may comprise a quick response (QR) payment code for the cryptocurrency exchange.

Further alternatively, the interface provided to the customer to select the cryptocurrency exchange may comprise a first further token that includes the token representing the payment request, wherein the first further token allows the customer to authorize the cryptocurrency exchange to send the payment gateway a second further token including the first further token that allows the payment gateway to retrieve a balance amount and a transaction history of the cryptocurrency wallet of the customer.

The payment gateway may perform a risk assessment for the payment request based at least in part on the shopping basket details and the transaction history of the cryptocurrency wallet of the customer.

If the risk assessment is satisfactory, the payment gateway may use the second further token to request the cryptocurrency exchange to transfer the equivalent cryptocurrency amount from the cryptocurrency wallet of the customer to the cryptocurrency wallet of the payment gateway.

The payment gateway may generate a non-fungible token (NFT) representing the risk assessment for the payment request.

The payment gateway may store the NFT in a customer profile of the customer.

The risk assessment may comprise one or both of an AML risk assessment and a fraud risk assessment.

The token representing the payment request, and the first and second further tokens, may each comprise an encrypted JSON Web Token (JWT).

The present invention also provides a method, comprising:
receiving, at a payment gateway, a payment request and shopping basket details of a customer from a merchant, wherein the payment request comprises a request for the payment gateway to pay a fiat currency amount to the merchant after an equivalent cryptocurrency amount has been transferred from a cryptocurrency wallet of the customer to a cryptocurrency wallet of the payment gateway;
generating a token representing the payment request;
storing the token and the shopping basket details for subsequent processing of the payment request by the payment gateway;
providing an interface to the customer to select a cryptocurrency exchange to transfer the equivalent cryptocurrency amount from the cryptocurrency wallet of the customer to the cryptocurrency wallet of the payment gateway;
requesting the cryptocurrency exchange to sell the equivalent cryptocurrency amount in the cryptocurrency wallet of the payment gateway for the fiat currency amount;
receiving a transfer of the fiat currency amount from the cryptocurrency exchange to the payment gateway;
notifying the merchant and the customer that the payment request has been successfully processed by the payment gateway;
settling the payment request by transferring the fiat currency amount from the payment gateway to the merchant.

The present invention also provides a non-transitory machine-readable medium having stored thereon machine-readable instructions executable to cause a machine to perform operations comprising:
receiving, at a payment gateway, a payment request and shopping basket details of a customer from a merchant, wherein the payment request comprises a request for the payment gateway to pay a fiat currency amount to the merchant after an equivalent cryptocurrency amount has been transferred from a cryptocurrency wallet of the customer to a cryptocurrency wallet of the payment gateway;
generating a token representing the payment request;
storing the token and the shopping basket details for subsequent processing of the payment request by the payment gateway;
providing an interface to the customer to select a cryptocurrency exchange to transfer the equivalent cryptocurrency amount from the cryptocurrency wallet of the customer to the cryptocurrency wallet of the payment gateway;
   requesting the cryptocurrency exchange to sell the equivalent cryptocurrency amount in the cryptocurrency wallet of the payment gateway for the fiat currency amount; receiving a transfer of the fiat currency amount from the cryptocurrency exchange to the payment gateway;
notifying the merchant and the customer that the payment request has been successfully processed by the payment gateway;
settling the payment request by transferring the fiat currency amount from the payment gateway to the merchant.

### BRIEF DESCRIPTION OF DRAWINGS

Embodiments of the invention will now be described by way of example only with reference to the accompanying drawings, in which:

FIG. 1 is a flow chart of a method for a secure and compliant multi-cryptocurrency payment gateway according to an embodiment of the present invention.

FIG. 2 is an architecture diagram of a computer system for performing the method.

FIGS. 3 to 9 are user interfaces displayed in a customer browser during the method.

FIGS. 10 and 11 are data flow diagrams of example implementations of the method.

### DETAILED DESCRIPTION

Prior to a description with reference to the drawings, to help understanding of the present invention, terms used in this specification are described in brief.

Payment gateway: sits in between a consumer and a merchant and ensures that funds are transferred securely and correctly when a transaction is performed. They usually integrate with multiple channels and allow merchants to provide multiple payment options to consumers. When processing credit card payments, these gateways provide value added services such as real-time anti-fraud assessments to minimize a merchant's exposure to fraudulent transactions.

Cryptocurrency: a form of electronic money created from code using an encrypted string. Ownership of cryptocurrency is usually recorded in a cryptographically encrypted immutable sequence of data blocks called a blockchain. The most popular cryptocurrencies allow owners to maintain anonymity and privacy because ownership is linked to a wallet address which is usually just a cryptographic public key.

Cryptocurrency exchange: an entity that allows customers to trade cryptocurrencies. They also provide means to trade cryptocurrencies with fiat money (or fiat currencies).

Public key cryptography: a method by which data is encrypted and decrypted using two different keys: a private key and a public key. The public key is derived from the private key. However, it is not possible to derive the private key from the public key. Public key cryptography is asymmetric: ie, data encrypted with a public key can only be decrypted with the corresponding private key and vice-versa.

JWT: an open internet standard used to securely transfer claims (ie, pieces of information) between two parties. These claims are encrypted using public key cryptography, and digitally signed or integrity protected using a message authentication code (MAC). A MAC is a tag which confirms that the message from the stated sender has not been changed.

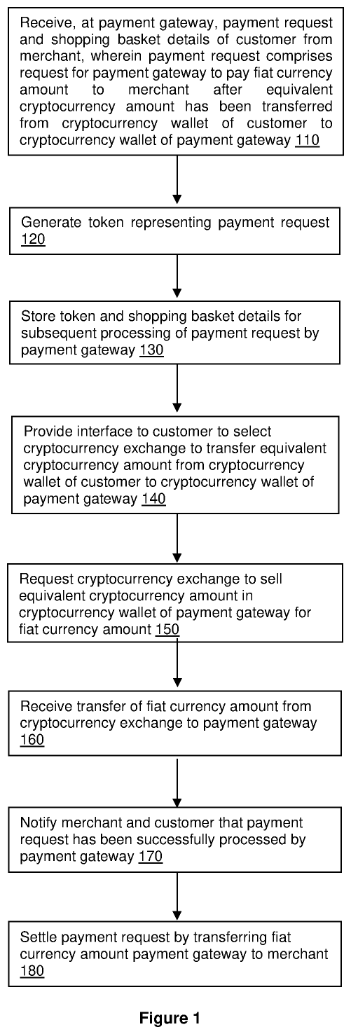

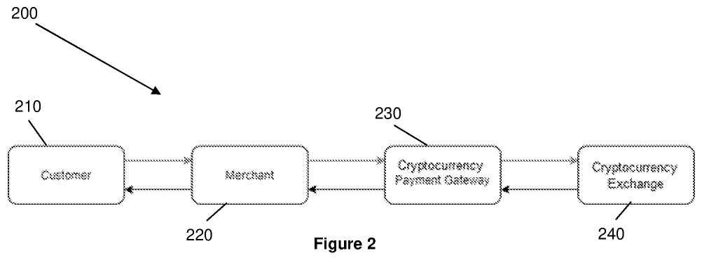

FIG. 1 is a flow chart of a method 100 for providing a secure and compliant multi-cryptocurrency payment gateway according to an embodiment of the present invention. The method 100 may be implemented as software executing in a computer system 200 illustrated in FIG. 2. The computer system 200 may comprise a customer browser 210, merchant web page 220, payment gateway 230, and cryptocurrency exchange 240 communicating with one another over a network.

The method may start at step 110 by receiving, at the payment gateway 230, a payment request and shopping basket details of a customer 210 from a merchant 220. The payment request may comprise a request for the payment gateway 230 to pay a fiat currency amount to a bank account of the merchant 220 after an equivalent cryptocurrency amount has been transferred from a cryptocurrency wallet of the customer 210 to a cryptocurrency wallet of the payment gateway 230.

Next, at step 120, a token T1 representing the payment request may be generated by the payment gateway 230. At step 130, the token and the shopping basket details may be stored at the payment gateway 230 for subsequent processing of the payment request by the payment gateway 230.

At step 140, an interface may be provided to the customer 210 to select a cryptocurrency exchange 240 to transfer the equivalent cryptocurrency amount from the cryptocurrency wallet of the customer 210 to the cryptocurrency wallet of the payment gateway 230.

At step 150, the payment gateway 230 may request the cryptocurrency exchange 240 to sell the equivalent cryptocurrency amount in the cryptocurrency wallet of the payment gateway 230 for the fiat currency amount.

A transfer of the fiat currency amount from the cryptocurrency exchange 240 to a bank account of the payment gateway 240 may be received at step 160.

At step 170, the merchant 220 and the customer 210 may be notified by the payment gateway 230 that the payment request has been successfully processed.

The method 100 may end at step 180 by settling the payment request by transferring the fiat currency amount from the bank account of the payment gateway 230 to the bank account of the merchant 220. The transfer of the fiat currency amount may be processed by generating a digital credit card that allows the payment gateway 230 to pay the fiat currency amount to the merchant as a regular credit card payment.

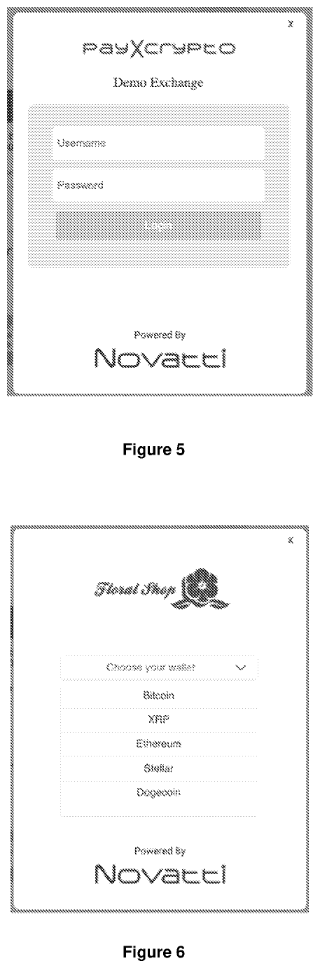

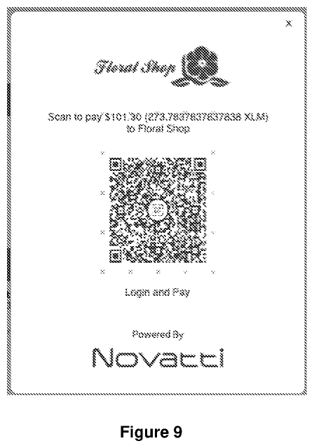

Referring to FIG. 5, the interface provided to the customer 210 to select the cryptocurrency exchange 240 may comprise a login URL of the cryptocurrency exchange 240. Alternatively, as shown in FIG. 9, the interface provided to the customer 210 to select the cryptocurrency exchange 240 may comprise a QR payment code for the cryptocurrency exchange 240.

In these embodiments, the cryptocurrency exchange 240 may authenticate the customer 210, and the customer 210 may use the cryptocurrency exchange 240 to process a transfer the equivalent cryptocurrency amount from the cryptocurrency wallet of the customer 210 to the cryptocurrency wallet of the payment gateway 230.

In alternative embodiments, the payment gateway 230 may perform risk assessments for the payment request. In these embodiments, the interface provided to the customer 210 to select the cryptocurrency exchange 240 may comprise a first further token T2 that includes the token T1 representing the payment request. The first further token T2 may allow the customer 210 to authorize the cryptocurrency exchange 240 to send the payment gateway 230 a second further token T3 that includes the first further token T2 and which allows the payment gateway 230 to retrieve a balance amount and a transaction history of the cryptocurrency wallet of the customer 230 from the cryptocurrency exchange 240.

The payment gateway 230 may then perform a risk assessment for the payment request based at least in part on the shopping basket details, and the balance amount and the transaction history of the cryptocurrency wallet of the customer 210. If the risk assessment is satisfactory, the payment gateway 230 may use the second further token T3 to request the cryptocurrency exchange 240 to transfer the equivalent cryptocurrency amount from the cryptocurrency wallet of the customer 210 to the cryptocurrency wallet of the payment gateway 230.

The payment gateway 230 may generate a non-fungible token (NFT) representing the risk assessment for the payment request. The payment gateway 230 may also store the NFT in a customer profile of the customer 210.

The risk assessment performed by the payment gateway 230 may comprise one or both of an AML risk assessment and a fraud risk assessment. The token representing the payment request T1, and the first and second further tokens T2, T3, may each comprise an encrypted JWT.

The following Examples are intended to illustrate the invention. They are not intended to limit the scope of the invention.

### Example 1—Non-Tokenized Direct Processing at Cryptocurrency Exchange

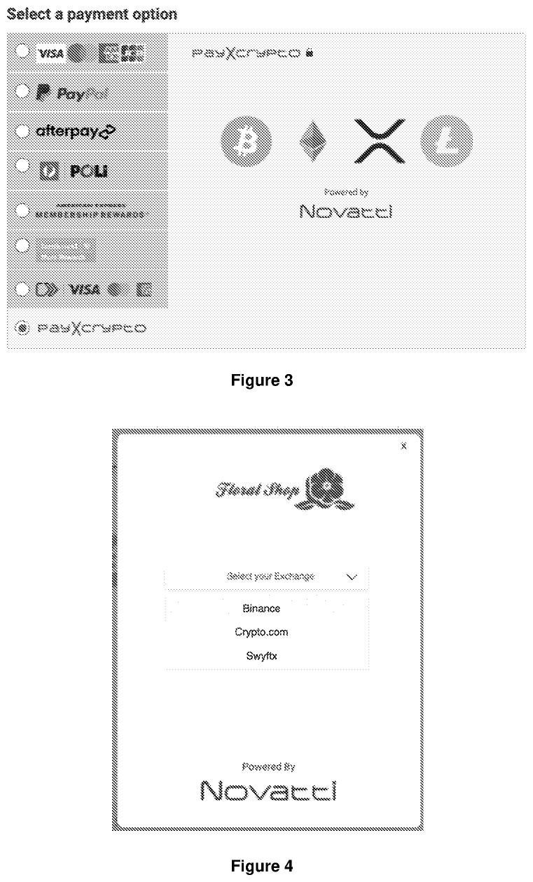

In this example, FIGS. 3 to 8 are user interface mock-ups displayed in a customer browser 210 showing a user experience using Stellar Lumens as a selected cryptocurrency to pay for a shopping basket on a merchant web page 220.

FIG. 3 shows a hosted payment page which is embedded into the checkout page of a merchant's website 220. Options to select payment with cryptocurrencies are provided. Once a cryptocurrency payment option is selected, a customer 210 may select a cryptocurrency exchange 240 at which their wallet is held. In FIG. 4, the cryptocurrency exchange 240 is selected by the customer 210.

FIG. 5 shows that the customer 210 is redirected to a login page at the selected cryptocurrency exchange 240. Once the customer 210 logs in, the list of wallets with sufficient balances is displayed, and they select the wallet/cryptocurrency, as shown in FIG. 6.

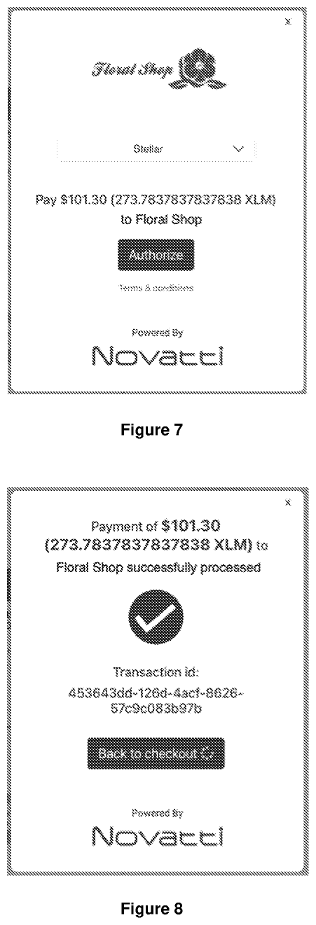

FIG. 7 shows conversion rate being presented to the customer 210 for review and authorization of payment.

FIG. 8 is the payment confirmation page which is shown before the customer 210 is redirected back to the merchant's website 220.

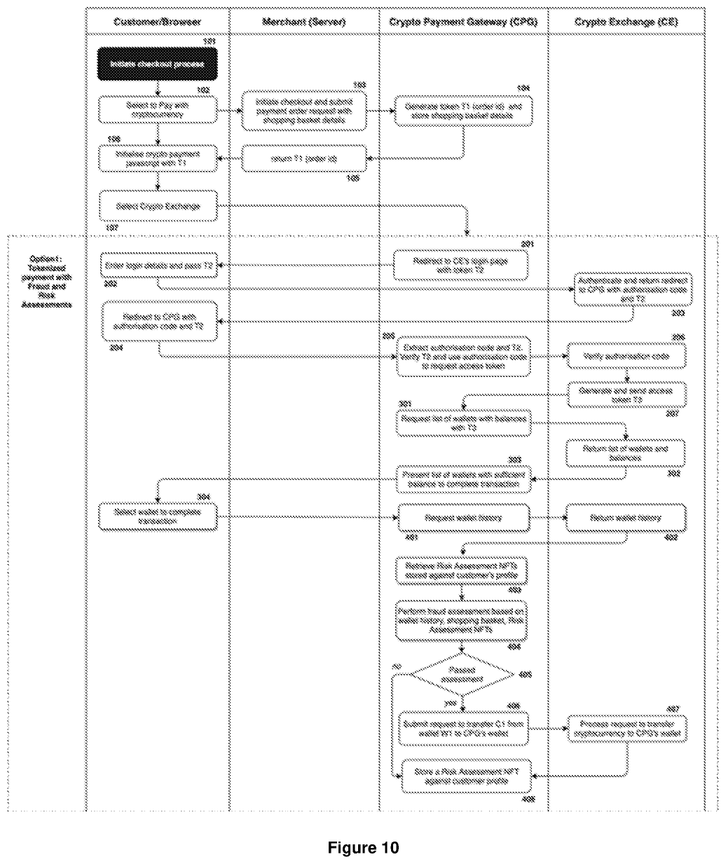

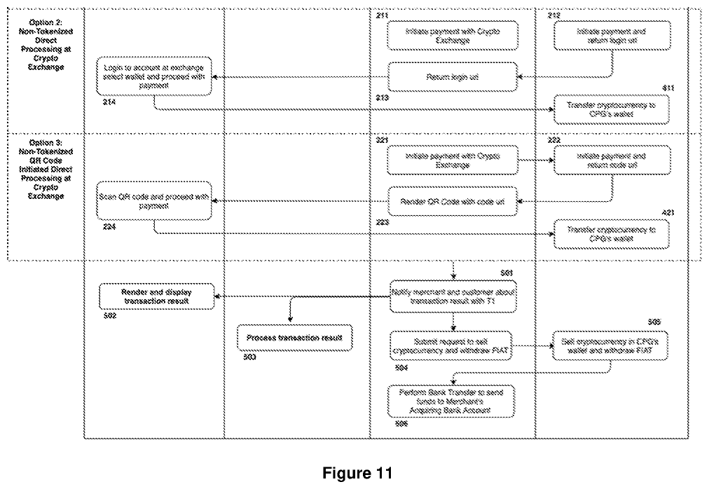

FIGS. 10 and 11 are end-to-end data flow diagrams which describe stages of this Example 1 in further detail.

### Initialization of Payment Process and Selection of Cryptocurrency Exchange

A customer browser 210 initiates checkout process on a merchant server 220 at step 101. At step 102, the customer 210 select cryptocurrency as the payment method. The merchant website 220 passes shopping basket details to the payment gateway (PG) 230 and requests a first token (T1) to track the end-to-end payment flow.

The PG 230 generates a token T1 and stores the shopping basket details against that token T1 at step 104. T1 is returned to the merchant website 220 at step 105. The merchant's website 220 in turn passes the T1 to the customer's browser 210. The checkout page uses token T1 to initialise a cryptocurrency payment process and presents the customer 210 with available cryptocurrency exchanges 240. In step 107, the customer 210 selects a cryptocurrency exchange (CE) 240.

### Authentication of Customer and Granting Access to Crypto Payment Gateway to Process Payment

In the example, option 2 shown in FIG. 11 is used to allow user credential based authentication and payment mechanisms presented by the selected CE 240 to be leveraged to complete the payment.

The flow embodied at steps 211-214 and 411 allows cryptocurrency payment capabilities available at the CE 240 to be leveraged. PG 230 initiates a cryptocurrency request in step 211. CE 240 generates and returns a login URL against the request in step 212. This login URL is passed back to the customer 210 in step 213. The customer 210 authenticates and authorizes the transfer at CE 240 in step 214 and cryptocurrency is transferred to PG's 230 wallet in step 411.

### Notification of Transaction Result and Fund Settlement

Referring to FIG. 11, at steps 501-503, customer 210 and merchant 220 are notified about the transaction. A request to sell the cryptocurrency in PG's 230 account at the CE 240 is submitted and the fiat currency amount is withdrawn in steps 504 and 505.

Funds in fiat currency are transferred from PG's 230 bank account to the merchant's 220 bank account in step 506 to complete the settlement process.

### Example 2—Non-Tokenized QR Code Initiated Direct Processing at Cryptocurrency Exchange

### Initialization of Payment Process and Selection of Cryptocurrency Exchange

This same process flow described in Example 1 above is used for this stage in this Example 2.

### Authentication of Customer and Granting Access to Crypto Payment Gateway to Process Payment

In the example, option 3 shown in FIG. 11 is used which allows QR code based authentication and payment mechanisms presented by the CE 240 to be leveraged to complete the payment.

FIG. 9 is a mock-up of a QR code based authentication page presented by a CE 240 to trigger optional flow 3 in FIG. 10. Flow option 3, which embodies steps 221-224 and 421, is similar to option 2 in Example 1, but incorporates a QR code based authentication mechanism. This is useful for customers 210 who prefer to complete the payment using a mobile device. PG 230 initiates a cryptocurrency request in step 221.

CE 240 generates and returns a code URL against the request in step 222. PG 230 renders a QR code based on the code URL and presents it to the customer 210 in step 223. The customer 210 scans the QR code in step 224 and authorizes the payment, and cryptocurrency is transferred to PG's 230 wallet in step 421.

### Notification of Transaction Result and Fund Settlement

This same process flow described in Example 1 above is used for this stage in this Example 2.

### Example 3-Tokenized Payment with Fraud and Risk Assessments

### Initialization of Payment Process and Selection of Cryptocurrency Exchange

This same process flow described in Examples 1 and 2 above is used in this Example 3.

### Authentication of Customer and Granting Access to Crypto Payment Gateway to Process Payment

In this Example 3, option 1 shown in FIG. 10 is used for this stage. At step 201 the appropriate login URL is generated with token T2 based on the selected exchange. The customer 210 enters user credentials to the presented login screen.

At step 203, CE 240 authenticates and redirects the customer 210 back to PG 230 with an authorization code and token T2. PG 230 extracts the authorization code and uses to the authorization code to request an access token T3. T2 is used to link T3 with the shopping basket details stored against T1.

These custom claims are encrypted by the PG 230 using the CE's 240 public key to ensure that it cannot be viewed/tampered with while it is passed through the customer's browser 210 to the CE 240. Once T2 is generated, the customer's browser 210 is redirected to the CE's 240 login page with T2.

Retrieval of Wallets with Sufficient Balance and Authorization of Payment

Token T3 is used to retrieve the customer's 210 list of wallets with cryptocurrency, their balances, and the conversion rate to a target fiat currency, in steps 301 and 302.

At step 303, PG 230 filters the list of wallets and returns only those that have sufficient balance to complete the payment, along with the balances and the conversion rate to the target fiat currency.

At step 304, the customer 210 selects a wallet W1 and authorizes the payment in step 305.

Retrieval of Transaction History of Authorized Wallet, Anti-Fraud Assessments and Perform Transfer (Payment) from Authorized Wallet

Referring to option 1 in FIG. 10, at step 401, the PG 230 requests the transaction history of W1 using T3. The CE 240 returns transaction history of W1 at step 402. At step 403, the PG 230 retrieves all risk assessment NFTs related to the customer 210 profile 210. The customer 210 profile may be determined based on identification details retrieved from the CE 240.

At step 404, the PG 230 performs AML and anti-fraud assessments based on the shopping basket details, merchant's 220 category and returned transaction history. A decision is made at step 405 to proceed with or reject the transaction.

If risk assessment is successful, PG 230 issues a transfer request to send C1 from W1 to PG's 230 wallet at step 406. The CE 240 performs the requested transfer at step 407.

At step 408, a risk assessment NFT for the transaction is stored against the customer 210 profile.

### Notification of Transaction Result and Fund Settlement

This same process flow described in Examples 1 and 2 above is used for this stage in this Example 3.

Embodiments of the present invention provide a system and related method that are both generally and specifically useful for providing a secure and compliant multi-cryptocurrency payment gateway.

Embodiments of invention advantageously provide a solution which allows consumers and merchants to be identified, and anti-fraud assessments to be performed when processing cryptocurrency-based payments. Merchants are identified when onboarding and provisioning an account at the payment gateway, consumers are identified using the KYC (Know Your Customer) and onboarding processes at the cryptocurrency exchange, and anti-fraud assessments are performed based on the transaction history of the customer's wallet, which is maintained at a cryptocurrency exchange.

Embodiments of the invention also provide the following advantages:
1. Allows payment gateways to be introduced to the cryptocurrency landscape. With currently available technology, merchants need to directly integrate with cryptocurrency exchanges via APIs to facilitate payments using cryptocurrency. The integration methods available with cryptocurrency exchanges are quite different from those used when processing credit card, debit card or stored value wallets. By introducing a cryptocurrency payment gateway, merchants are provided with an integration method that is the same as that used when accepting credit card payments from consumers.
2. Allows merchants to provide cryptocurrency as an option alongside other payment methods (eg, credit card, debit card or stored value wallets), to consumers.
3. Minimizes or avoids the risk of fraudulently-obtained cryptocurrency being used in a transaction, by looking at the transaction history of the wallet of the consumer, and checking the source of the cryptocurrency.
4. A three token mechanism which allows the shopping basket details to be used together with the consumer's wallet history and provide an aggregate risk assessment score.
5. A settlement mechanism when accepting cryptocurrency payments by provisioning a digital credit card and then using the card scheme rails to transfer the funds to the relevant merchant's acquiring wallet.

Unless the context requires otherwise, the word “comprising” means “including but not limited to,” and the word “comprises” has a corresponding meaning.

Any reference to prior art is not an admission that the prior art is common general knowledge.

The scope of the invention supported by the above examples is defined by the claims that follow.

1-12. (canceled)

13. A method for processing a payment from a customer to a merchant, the method comprising the steps of:
providing a gateway to a cryptocurrency exchange;
receiving by the gateway, a request from the merchant for the payment in fiat currency;
receiving by the gateway, a selection from the customer to fund the payment to the merchant in cryptocurrency using a customer wallet hosted for the customer by the cryptocurrency exchange;
processing fiat-to-cryptocurrency and cryptocurrency-to-fiat currency exchanges at the cryptocurrency exchange using the customer wallet and a gateway wallet hosted for the gateway by the cryptocurrency exchange, in response to requests by the gateway;
receiving by the gateway, notification from the cryptocurrency exchange that the fiat-to-cryptocurrency and cryptocurrency-to-fiat currency exchanges have been completed; and
paying the fiat currency to the merchant by the gateway without involving the merchant in the fiat-to-cryptocurrency and cryptocurrency-to-fiat currency exchanges.

14. The method of claim 13, wherein the requests by the gateway to process the fiat-to-cryptocurrency and cryptocurrency-to-fiat currency exchanges at the cryptocurrency exchange are based on first, second, and third tokens generated by the gateway, and wherein:
the first token represents details of the customer and the payment;
the second token represents a balance amount and transaction history of the customer wallet; and
the third token represents a risk assessment for the customer and the payment.

15. The method of claim 14, wherein the first, second and third tokens are stored by the gateway in a customer profile of the customer.

16. The method of claim 14, wherein the risk assessment comprises one or both of an anti-money laundering (AML) risk assessment and a fraud risk assessment.

17. The method of claim 16, wherein the first, second, and third tokens each comprise an encrypted JSON Web Token (JWT).

18. The method of claim 13, further comprising, presenting by the gateway, multiple different cryptocurrency exchanges for the customer to select from to fund the payment.

19. A system for processing a payment from a customer to a merchant, the system comprising:
a memory and a processor configured by instructions stored in the memory to perform operations comprising:
providing a gateway to a cryptocurrency exchange;
receiving by the gateway, a request from the merchant for the payment in fiat currency;
receiving by the gateway, a selection from the customer to fund the payment to the merchant in cryptocurrency using a customer exchange wallet hosted for the customer by the cryptocurrency exchange;
processing fiat-to-cryptocurrency and cryptocurrency-to-fiat currency exchanges at the cryptocurrency exchange using the customer wallet and a gateway exchange wallet hosted for the gateway by the cryptocurrency exchange, in response to requests by the gateway;
receiving by the gateway, notification from the cryptocurrency exchange that the fiat-to-cryptocurrency and cryptocurrency-to-fiat currency exchanges have been completed; and
paying the fiat currency to the merchant by the gateway without involving the merchant in the fiat-to-cryptocurrency and cryptocurrency-to-fiat currency exchanges.
